(19) United States
(12) Patent Application Publication
(10) Pub. No.: US 2006/0212557 A1
(43) Pub. Date: Sep. 21, 2006

(54) Hmi system for operating and monitoring a technical installation by means of mobile operating and monitoring device and secure data transmission

(76) Inventors: Gottfried Rieger, Furth (DE); Ulrich Sinn, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/568,116

(22) PCT Filed: Jul. 28, 2004
(86) PCT No.: PCT/EP04/08456

§ 371 Date: Feb. 13, 2006

(30) Foreign Application Priority Data
Aug. 29, 2003 (DE) 203 13 562.8

(51) Int. Cl. G06F 15/173

(52) U.S. Cl. 709/223

(57) ABSTRACT

Disclosed is an HMI system comprising at least one mobile operating and monitoring device for the automation components of a technical installation and a radio link for contactless data transmission between the mobile operating and monitoring device and the automation components. A first firewall is provided for securing data transmission from the automation components to the mobile operating and monitoring device while a second firewall is supplied for securing data transmission from the mobile operating and monitoring device to the automation components. The advantage of the invention consists of the fact that bi-directional data traffic on the radio link between a mobile operating and monitoring device and the other automation components of a technical installation can also be secured by using two preferably equally effective firewalls.

### CROSS REFERENCE TO RELATED APPLICATIONS

This application claims priority to the German application No. 20313562.8, filed Aug. 29, 2003 and to the International Application No. PCT/EP2004/008456, filed Jul. 28, 2004 which are incorporated by reference herein in their entirety.

### FIELD OF INVENTION

The invention relates to a HMI system with at least one mobile operating and monitoring device for the automation components of a technical installation.

### BACKGROUND OF INVENTION

Technical installations are all types of technical devices and systems both in an individual arrangement and also in data systems networking, over a field bus for example. For industrial applications these include individual operating resources such as drives, processing machines. A technical installation can however also be a production installation, in which an entire technical process e.g. a chemical installation or production line, is operated with locally distributed operating resources. Technical installations are controlled and operated with specific digital data processing systems, also called automation components. On the one hand components used for direct control of the technical installation, i.e. Programmable Logic Controllers PLC, are present in such a system. To relieve the load on these controller s automation systems feature further specific devices which form an interface for operating personnel. These are referred to as operating and monitoring devices, abbreviated to O&M devices, or as HMI devices, i.e. Human Machine Interface devices.

### SUMMARY OF INVENTION

The term HMI device is a generic term and encompasses all the components belonging to this group of devices. Operator panels, abbreviated to “OP” might be mentioned as an example of such devices. These can be embodied as stationary or mo bile devices. HMI devices are used in a networked automation system as an aid for operating personnel, to allow display and operation of the process data of the technical installation to be controlled. The function is referred to as “Supervisor Control and Data Acquisition” (SCADA). To this end the HMI device as a rule has a specific hardware design, i.e. it has a touch screen for example and is especially shielded against environmental influences. Furthermore specific software is executed on it. This provides functions which improve the convenience, quality and security of operation for an operator. Thus interactive process maps of the technical installation to be operated can be operated, planned into projects and generated using HMI devices. On the one hand this makes possible a selective display of reactions of the technical installation, mostly in the form of measured values and messages. On the other hand explicit specification of operating actions and data inputs makes it possible to put the technical installation into desired states.

A plurality of HMI devices are for example permanently integrated into an automation system in the form of terminals or operator panels as stationary components. In this case the plurality of the components is connected via a field bus which meets the requirements for fault tolerance and transmission security necessary for industrial applications. In automation technology these types of networks represent a self-contained system, and because of this characteristic are secure from outside accesses. If however in particular applications an automation systems is opened up, especially by connection to the Internet, for example to exchange process, operating and monitoring data between a local automation system and a remote location over the Internet, such an access point can be secured with known measures, such as the installation of a firewall for example, against outside access.

The situation is different if the HMI devices are not embodied exclusively as stationary devices, but also in the form of mobile operator panels. Such an automation system, of which the field bus is expanded by at least one radio link to a mobile operating and monitoring device, can continue to be regarded logically as self-contained. However the radio link represents an area which is in particular danger in relation to deliberate and accidental outside accesses. These can give rise in automation systems to effects which go beyond the known effects for example of virus attacks on private and commercial computers and computer networks. Thus not only are adverse commercial effects caused by a failure of the automation systems and a dependent manufacturing system to be feared in such a case. There is also the distinct possibility of the safety of persons in a manufacturing installation being called into question if remote accesses are undertaken on a radio link between a mobile operating and monitoring device and the further components of an automation system.

An object of the invention is thus to develop the design of an HMI system so that mobile operating and monitoring devices are incorporated into an automation system in a way that makes them secure from outside access.

The inventive HMI system with at least one mobile operating and monitoring device for the automation components of a technical installation features a radio link for wireless data transmission between the mobile operating and monitoring device and the automation components. A first firewall is provided to secure the data transmission from the automation components to the mobile operating and monitoring device, and a second firewall is provided to secure the data transmission from the mobile operating and monitoring device to the automation components.

The invention has the advantage, that by using firewalls, i.e. tried and tested means for securing the acceptance of data over wired communication links, the bidirectional data traffic on a radio link between a mobile operating and monitoring device and the further components for automation of a technical installation can also be secured.

Advantageously the second firewall is integrated into an automation component. The need for extra hardware can be avoided in this way. If the a utomation components feature a radio interface, also called a radio access point, for connection to the radio link, an integration of the second firewall into this radio interface is especially advantageous. This then allows an especially good securing of all automation components lying beyond this, if these are jointly interconnected to the radio interface via a field bus.

Furthermore the first firewall is advantageously integrated directly into the mobile operating and monitoring device. In this way manipulations can be rendered more difficult, especially with an encapsulated embodiment of the housing of the mobile operating and monitoring device.

Finally the security of data transmission of the inventive HMI system can be increased by the automation components featuring a radius server which is advantageously also connected as a singular component to the field bus. In addition to a filter mechanism of the firewall the radius server also offers a remote authentication dial-in service. This makes possible an authentication of the user of the mobile operating and monitoring device, i.e. a secured user administration.

### BRIEF DESCRIPTION OF THE DRAWING

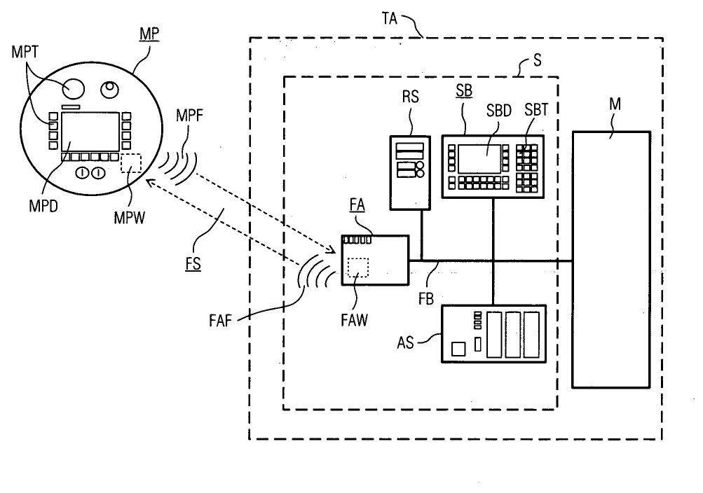

The invention will be explained in greater detail below with reference to an exemplary embodiment shown in FIG. 1.

The technical installation TA in FIG. 1 has available to it technical operating resources M which for example can be part of a manufacturing or process technology installation. For their control automation components S are present which access the technical operating resources M over a field bus FB, especially by switching signals of measured value generators, position controllers and various other process instruments.

### DETAILED DESCRIPTION OF INVENTION

The automation components S in FIG. 1 have available for example an automation device AS, for example a Programmable Logic Controller PLC, which controls the technical resources M in real time if necessary. For operation and monitoring of the controller, the technical resources M, and e.g. of control, diagnosis, alarm handling and long-term monitoring processes executing a stationary operating and monitoring device SP is present, which can be embodied for example as an operator panel with a touch screen and means to mount it in the front of a switching cabinet. The stationary operating and monitoring device SP has a display SBD and a keyboard SBT for example. It is connected like the other automation components to a field bus FB.

In addition to the stationary operating and monitoring device SP, the HMI system shown in FIG. 1 has at least one mobile operating and monitoring device MP, for example a wireless hand-held terminal. This too has a display MPD and a keyboard MPT for example. Furthermore an emergency stop button and acknowledgement buttons and for example key switches can be provided.

The mobile operating and monitoring device MP exchanges data wirelessly over a radio link FS with the automation components S of the technical installation TA. In this case the radio link FS is embodied bidirectionally. A first data stream in a direction of transmission FAF running from the automation components S to the operating and monitoring device MP preferably transfers indications, alarms, messages, measured values and much more in order to keep the user informed especially about the status of the technical installation TA. A second data stream running in a direction of transmission MPF from an operating and monitoring device MP to the automation components S transfers in particular acknowledgements, commands and much more in order to modify the status of the technical installation TA in a manner required by the user of the mobile operating and monitoring device MP.

In accordance with the invention the bidirectional data transmission on the radio link FS is secured by a pair of firewalls MPW and FAW, preferably embodied in the same way, with the first firewall MPW securing a data transmission of the first data stream in the direction FAF and the second firewall FAW securing the transmission of the second data stream in the direction MPF. The security procedures loaded and active in the firewalls MPW and FAW advantageously match each other or at least have the same effects.

Advantageously the first firewall MPW is directly integrated into a mobile operating and monitoring device MP. Correspondingly the second firewall FAW is advantageously integrated into an automation component S. In the preferred embodiment of the invention shown in FIG. 1 the second firewall FAW is directly integrated into a radio interface FA connected to the field bus FB, which links the automation components S to the radio link FS.

In accordance with a further embodiment already shown in FIG. 1, the automation components S feature an additional RADIUS Server RS which is advantageously also connected to the field bus FB. This provides an additional remote authentication dial-in user service. This can be used to check the authorization of a user of the mobile operating and monitoring device MP.

The inventive HMI system shown as an example in FIG. 1 thus, despite a radio interface to a mobile operating and monitoring device MP which poses inherent dangers to security, thus exhibits an outstanding protection against outside access. This can be further improved by additional measures such as for example the inclusion of a radius server.

1.-9. (canceled)

10. A Human-Machine-Interface (HMI) system, comprising:
at least one mobile operating and monitoring device for controlling automation components of a technical installation;
a radio link for wireless data transmission between the mobile operating and monitoring device and the automation components;
a first firewall for securing data transmission from the automation components to the mobile operating and monitoring device; and
a second firewall for securing data transmission from the mobile operating and monitoring device to the automation components.

11. The HMI system in accordance with claim 10, wherein the first and second firewalls include essentially the same security procedures.

12. The HMI system in accordance with claim 10, wherein the first firewall is an integral part of the mobile operating and monitoring device.

13. The HMI system in accordance with claim 12, wherein the mobile operating and monitoring device is encapsulated.

14. HMI system in accordance with claim 10, wherein the second firewall is an integral part of at least one of the automation components.

15. The HMI system in accordance with claim 14, wherein the automation component comprises a radio interface for establishing the radio link, the second firewall being an integral part of the radio interface.

16. The HMI system in accordance with claim 15, wherein the automation components are connected by a field bus, the radio interface connected to the field bus.

17. The HMI system in accordance with claim 10, wherein the automation components include a radius server.

18. The HMI System in accordance with claim 15, wherein the automation components include a radius server connected to the field bus.
